(19) United States
(12) Patent Application Publication
(10) Pub. No.: US 2005/0224114 A1
(43) Pub. Date: Oct. 13, 2005

(54) Breakaway pipe coupling with automatic shutoff

(75) Inventors: Christopher Michael Cook, Oskaloosa, IA (US); Jerry Bottenfield, Oskaloosa, IA (US)

Correspondence Address: FITCH EVEN TABIN AND FLANNERY, 120 SOUTH LA SALLE STREET, SUITE 1600, CHICAGO, IL, 60603-3406, US

(73) Assignees: Christopher Michael Cook; Jerry Bottenfield

(21) Appl. No.: 10/819,717

(22) Filed: Apr. 7, 2004

(51) Int. Cl. F16K 17/36

(52) U.S. Cl. 137/68.14

(57) ABSTRACT

A pipe coupling for use with a fire hydrant or like has automatic shut-off features in the event of breakage of the fire hydrant. The breakaway pipe coupling includes an extension join to a valve body with a flow passage way extending through the extension and valve body. A shut-off valve is moveably mounted to the extension and is bois for movement toward a valve seat located in the valve body. A wedge extends between the extension and the shut-off valve, wedging the shut-off valve in a open position away from the valve seat. Extension and valve are separably joined together in that the extension includes a frangible portion which severs upon application of an impact force to pipe coupling. This allows the wedge to become dislodged, with the shut-off valve being urged in a position towards the valve seat.

### BACKGROUND OF THE INVENTION

1. Field of the Invention

The present invention pertains to pipe couplings for water supply lines and in particular to pipe couplings which provide an automatic shut-off if the line should suddenly become open.

2. Description of the Related Art

In a number of different applications, it is important that the flaw of water be quickly and automatically stopped should a break in the water supply line occur. For example, should fire hydrants be subject to a lateral impact or blow from a vehicle, damage to all or some portion of the water supply line, including the fire hydrant itself, is likely. The various portions of a fire hydrant water supply line have widely varying material and replacement costs. It is desirable to provide a sacrificial portion or special purpose reusable portion which limits resulting damage in a manner which is most economical for subsequent repair of the water line.

Typically, fire hydrants and other water supply devices are located remotely from the main water supply. For example, municipal water supply lines are often buried deep within the ground and a riser portion of considerable height is required to reach the ground surface were the fire hydrant is located. Various arraignments have been proposed for riser constructions, including arrangements described in the U.S. Pat. Nos. 4,127,142; 4,717,178; 5,609,179 and 6,401,745. In each of these arrangements some provision is made for automatic shut-off of2 water flow through the riser portion of the water line. For example, in the U.S. Pat. No. 4,127,142 a valve member is blocked open by a bar welded to a sandwich flange. Weakened bolts holding the sandwich flange are severed upon impact, allowing the valve to close and thereby shut-off flow through the water line. The arrangement provides a slow closing feature to reduce water hammer. U.S. Pat. No. 4,717,178 employs a frangible ring to separate upper and lower barrel sections of a fire hydrant. U.S. Pat. No. 6,401,745 employs a pair of flaps which close to seal a cylindrical sleeve to prevent water flow to a fire hydrant. U.S. Pat. No. 5,609,179 employs a rod having a frangible end which, upon breaking, allows a valve disk to rotate to a closed position.

### SUMMARY OF THE INVENTION

Advances in the field of breakaway pipe couplings are constantly being sought. It is important that the more expensive components of a water line system be protected from damage when subjected to an impact force such as that of a motor vehicle. Also, it is important that water flow be quickly and reliably stopped upon breakage of some portion of the water line system. Accordingly, it is in object of the present invention to provide a breakaway pipe coupling having an improved automatic shut-off.

Related objects of the present invention include the provision of a breakaway pipe coupling with a sacrificial portion which reliably limits damage to a localized area, preventing damage to critical components of a water line system, such as a valve assembly.

A further object of the present invention is to provide a breakaway pipe coupling of the above-described type which reliably impedes water flow, upon damage to the system, which effectively stops or terminates flow at the point of breakage.

A further object of the present invention is to provide reliable stopping of water flow at a point of breakage in a fire hydrant supply system which provides a high capacity water flow at elevated pressures of 150 lbs. per square inch, or more. With such systems, even relatively small leakage can adversely impact an accident site with a substantial accumulation amount of water.

It has been found important that the valve member immediately achieve full closure upon activation, despite fouling of the valve surfaces. Due to the forces involved, a slight misalignment of the valve and valve seat might still result in a substantial closing of water flow at the breakage sight. However, due to the elevated flow rates and pressures involved, a substantial but incomplete valve closure might still allow a substantial amount of water to quickly accumulate an accident site. Its been found that, should valve misalignments occur during the first moments of a closing operation, the valve will not have an opportunity to adjust its position due to the substantial hydraulic forces involved.

These another objects according principles of the present invention are attained in [claim 1].

### BRIEF DESCRIPTION OF THE DRAWINGS

FIG. 1 is a perspective view of a pipe coupling constructed according principles of the present invention;

FIG. 2 is a top plan view thereof;

FIG. 3 is side elevational view thereof;

FIG. 4 is cross-sectional view taking along the line 4-4 of FIG. 2;

FIG. 5 is a cross-sectional view similar to that of FIG. 4, but showing valve in closed position; and

FIG. 6 is side elevational view showing the pipe coupling in combination with a fire hydrant.

### DETAILED DESCRIPTION OF THE PREFERRED EMBODIMENT

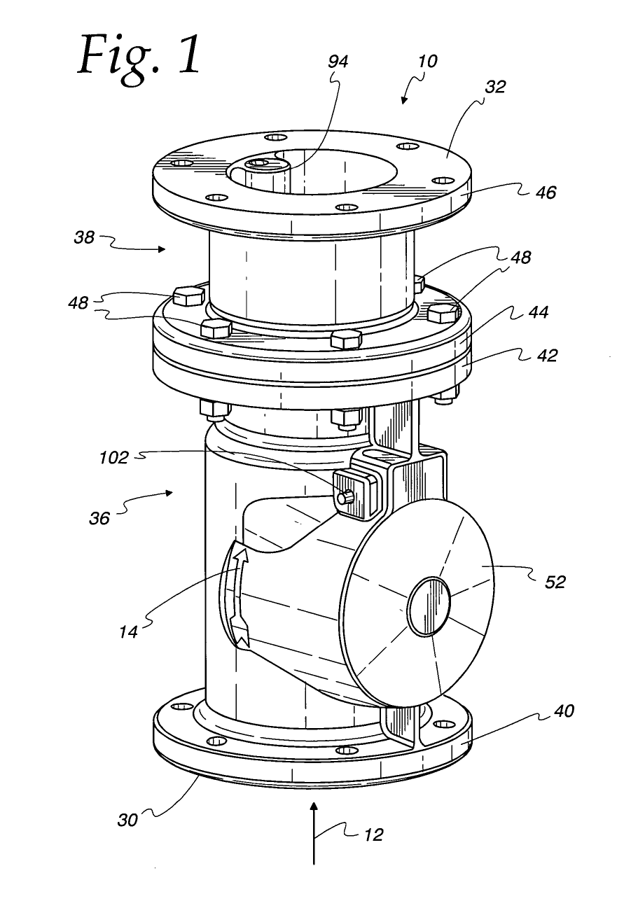

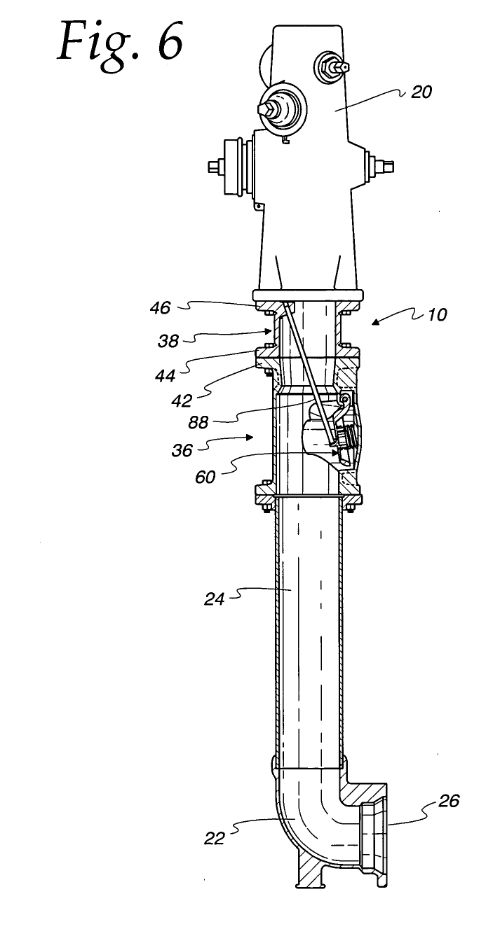

Referring know to the drawings and initially to FIG. 1, a pipe coupling according to principles of the present invention is generally indicated at 10. Pipe coupling 10 defines an eternal passage way for fluid flow in the direction of arrow 12. Arrow-shaped in FIG. 14 is provided on the body of the pipe coupling to provide a convenient indication to the installer or other workmen. Pipe coupling 10 has potential commercial application for use in large volume, high pressure fluid systems such as municipal water way systems. Pipe coupling 10 provides an improved automatic shut-off of fluid flow in the event of breakage of system components located downstream of the pipe coupling. With reference to FIG. 6, pipe coupling 10 is shown in combination with a municipal or commercial water way system in which a conventual fire hydrant 20 terminates flow from a main supply. An angle fitting 22 and riser pipe 24 provide connection to the main fluid supply couple to end 26 of coupling 22. In the example illustrated in FIG. 6, pipe coupling 10 provides automatic shut-off should the downstream component (herein hydrant 20) become damaged resulting in a rupturing of the fluid system. Such damaged to fire hydrant devices typically arises from accidental contact with a motor vehicle such as a passenger car or a piece of earth moving equipment. Damage could also arise from natural disasters such as an earth quake or debris-laden foot waters. Has indicated in the example system, pipe coupling 10 is employed to provide automatic shut-off of water flow under relatively high pressure conditions, such as those encounter immiscible and commercial water supply systems. You will be greatly appreciated by those skills of the art, that pipe coupling 10 could also can be employed with other pipping systems and fluids, such as crud oil, refined petroleum, or commercial fluids such as by products and commercial chemicals. Pipe coupling 10 provides automatic shut-off protection for downstream components such as the fire hydrant illustrated in the example, as well as pipe ridge crossings, expansion loops, or control valves which are susceptible to damage, resulting a rupture of the sued system. The pipe coupling 10 illustrated in the figures is disposed in a generally vertical orientation, but could be arranged in a horizontal or other non-vertical position as desired.

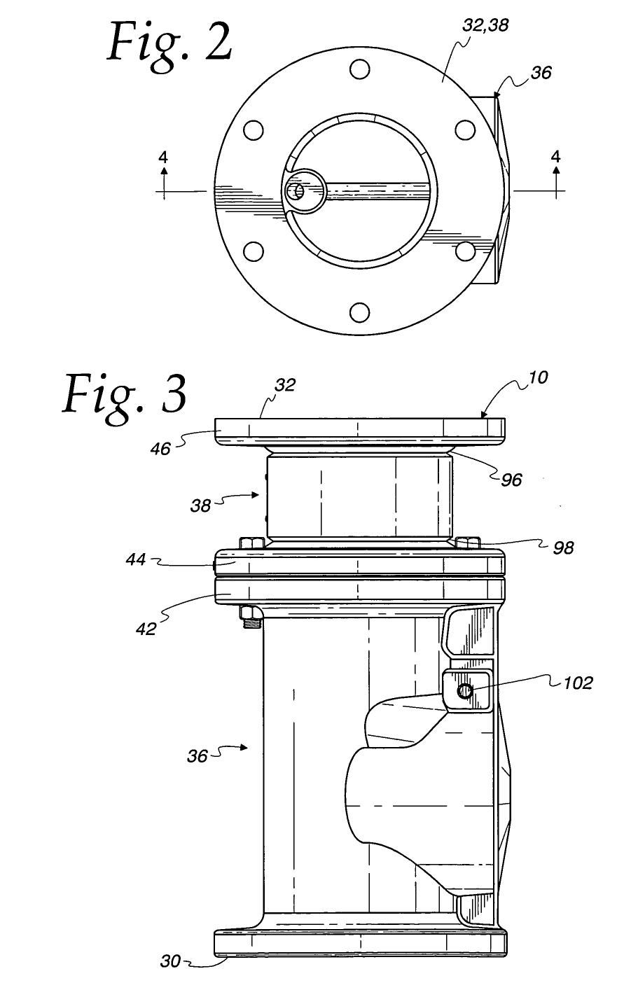

Referring know to FIGS. 1-4, pipe coupling 10 may be comprised of a continues unitary body from its inlet end 30 to its outlet and 32. However, as illustrated, it is generally preferred that the pipe coupling be provided in two parts including an up stream valve part generally indicated at 36 and a downstream extension part generally indicated at 38. Preferably, the valve part and extension part are provided with connecting flanges 40, 42 and 44, 46, respectively. The lower flange 44 of extension part 38 is secured to the upper flange 42 of valve part 36 by a series of shredded bolt fasteners 48, as is shown in the art. The upper flange 46 is connected to the downstream device to be protected, such as the fire hydrant 20 shown in FIG. 6. Unprotecting and above ground device such fire hydrant 20, it is assumed that the fire hydrant will most likely become damaged by inadvertent contact with a moving vehicle providing a sideways impact force which is off excess, usually perpendicular to the direction of arrow 12 (see FIG. 1). In this event, four reasons to be discussed herein, it is generally preferred that the upper flange 46 of extension part 38 be directly connected to the fire hydrant or other protected devise to provide the most direct transmission of impact force from the fire hydrant to the extension part 38. As indicated in FIG. 6, the lower flange of valve part 36 is connected to the fluid supply herein biser pipe 24.

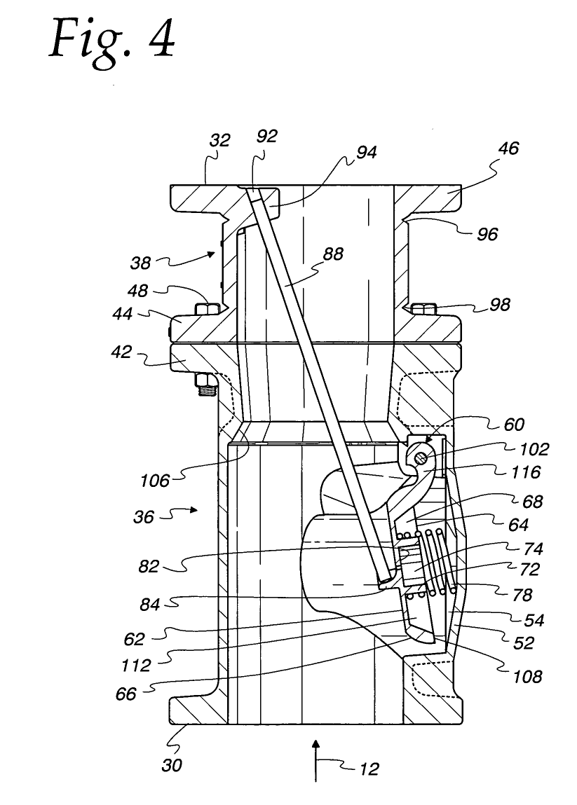

Referring know to FIG. 4, it can be seen that extension part 38 and valve part 36 defined quacksual water passage ways, with the bolted connection of flanges 42, 44 providing a fluid-type connection. With additional reference to FIG. 1, it can be seen at valve part 36 includes a sideways protrusion 52 defining a cavity 54 visible in FIG. 4. Cavity 54 receives a shut-off valve 60 having a generally flat plate-like structure with a end wall 62 and a skirt or a side wall 64 needing at outside corner 66 of predetermine curvature. Together, end wall 62 and side wall 64 cooperate to form a recess or cavity 68 at the under side of shut-off 60.

Referring again to FIG. 4, a generally cylindrical mounting lug 72 cooperates with end walls 62 to provide a hollow recess 74 opening in generally in the same direction as recess 68. The outside surface of log 72 provides a convenient attachment point for the upper end of coil spring 78 is generally preferred that coil spring 78 be maintained captive on the under side of shut-off valve 60. As indicated in FIG. 4, with shut-valve 60 in the fully open position, coral spring 78 is compressed by the outer wall of housing protrusion 52. An optional witness hole or weep hole 82 is formed in end wall 62 adjacent a cup-like packet member 84.

The biases force off spring 78 its restrained by a wedge member 88 having a lower end contacting pocket 84 in a upper end received in a passage way 92 formed in an internal protrusion 94 extending from extension part 38, in an inward direction, adjacent flange 46. In the preferred embodiment, passage way 92 and the upper end of wedge 88 are shredded for complementary shredded for joinder. Alternatively, the upper end of wedge 88 may be secured to extension part 38 using virtually any available means sufficient to maintain engagement between wedge 88 and extension part 38, despite impact forces applied to the extension part.

Referring again to FIG. 4, in a preferred embodiment, extension part 38 includes a frangible feature to insure that extension part 38 is ruptured upon application of an impact force to a protected device mounted downstream of the extension part. In the example system shown in FIG. 6, as mentioned, the impact force is anticipated to be applied to hydrant 20 which is securely bolted or other wise fasten to the downstream on 32 of extension part 38, for efficient transmission of the impact force to the extension part. As can be seen in FIG. 4, for example, extension part 38 is providing with two annular recesses 96, located adjacent flange 46 and annular recesses 98 located adjacent flange 44. The annular recesses provided lines of weakness in the body of extension part 38, causing the extension part to fail or rupture at the annular recesses. Preferably, the depth of the annular recesses is matched to the side walls and structure of the extension part to insure that application of a impact force to the fluid system will reliably result in breakage in the extension part, rather then the protected devise, herein hydrant 20 for the valve part 36. In a preferred embodiment, extension part 38 is intended to be the weakened sacrificial member which must be replaced after an automatic valve closing. As mentioned, the upper end of wedge 88 remains secure to protrusion 94 adjacent flange 46, thus insuring that the wedge 88 remains secure to a massive structure, such as the protected fire hydrant 20 after a successful automatic shut-off event.

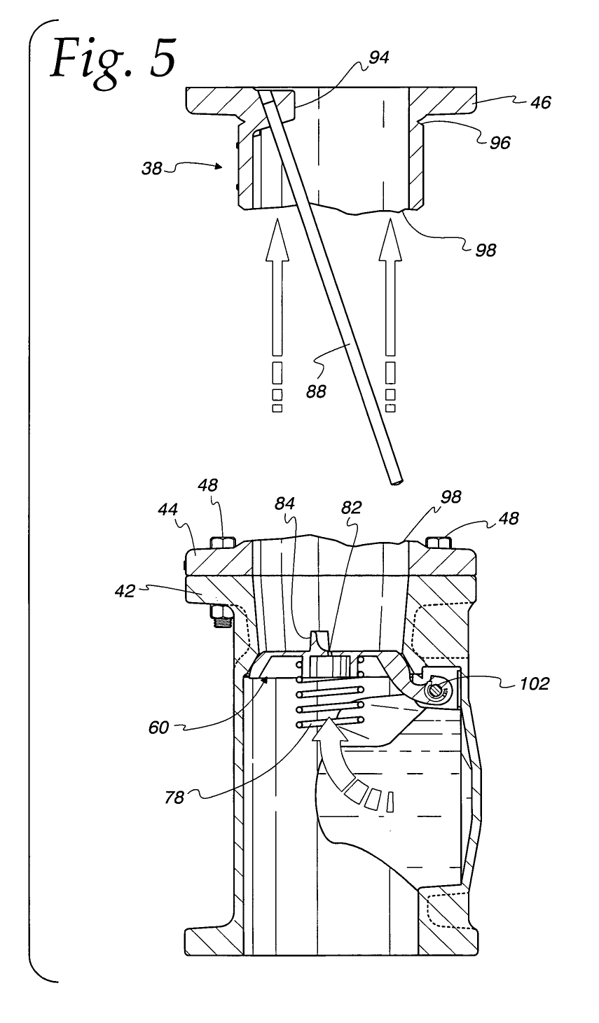

In operation, pipe coupling 10 provides automatic closure of flow through its internal passage way. In the example illustrated in FIG. 6, it is assumed that an impact force is laterally applied to the protected device or hydrant 20. This sideways force is transmitted to extension part 38 and causes the extension part to ruptured at ether analis 96, 98 or both. This allows the hydrant 20 to follow the lateral motion generated by the impact force, with wedge number 88 following the hydrant and remaining fixable coupled there to. As a result, the bottom end of the wedging number 88 used contacted with pocket 84, allowing shut-off valve 60 to rotate toward a closed position, away from housing protrusion 52, under force of spring 78. In a preferred embodiment, spring 78 provides only and initial motion to the shut-off valve, causing the shut-off valve to enter the fluid flow through the pipe coupling. On entry into the fluid flow, the free end of the shut-off valve contacts the upwardly directed fluid flow and is moved along with the direction of the fluid flow toward the closed position illustrated in FIG. 5. As mentioned, the underside of shut-off valve 60 is formed with a hollow recess which aids in capturing the fluid flow and enhance the displacing force made available by the fluid flow to quickly bring the shut-off valve 62 the close position illustrated in FIG. 5. During the closing operation, the shut-off valve 60 pivots in a clock wise direction about mounting pin 102.

Referring again to FIG. 4, the housing portion of valve part 36 defines a valve seat 106 immediately downstream of 10 102. Preferably, valve seat 106 has a frusto chronicle configuration looking at other conventual shapes, if desired. As mentioned, deskirt or side wall 64 of the check valve has an outside corner which is surrounded or curved. Preferably, the outside corner is continuously curved to present a convex seeding surface which engages the valve seat 106 with a line (ie circle) contact. It has been found that special attention must be paid to the seating operation of the check valve in an automatic shut-off event. Assuming a breakage or ruptured downstream of a check valve, a substantial flow is directed through the inter boar of valve part 36. Concurrently, it is assumed that wedge 88 is free to move in a downstream direction, clearing the wedging contact with pocket pd4 located on the topside of shut-off valve 60. This removes the restraint against expansion of spring 78, which urges the shut-off valve toward valve seat 106. The reference 108 is applied to the tip of shut-off valve 60, located at the bottom corner of side wall 64, opposite end 102. Initially, as can be seen FIG. 4, the top wall 62 of the shut-off valve is inclined away from the direction of fluid flow. Static fluid pressure urges the shut-off valve in the close position illustrated in FIG. 4. With wedge 88 being moved, spring 78 urges the shut-off valve 60 in a clock wise direction, initially bringing top wall 62 into alinement with the direction of fluid flow, preferably in axial direction with respect to valve part 36). At this point, the shut-off valve is in a neutral or unstable position and it is important that spring 78 continues control of the shut-off valve so as exposed the underside of the shut-off valve to fluid flow through the valve part. Upon the initial exposure of the underside of the shut-off valve 60 to the fluid flow, fluid pressure directs the shut-off valve toward a close position eliminating further need for spring 78 to urge the shut-off valve to its completed, closed position. As can be seen in FIG. 4, a cavity 112 is formed adjacent tip 108. Full pressure trapped in cavity 112 accelerates the closing of the shut-off valve. There after, pressure becomes trapped within a hollow mounted stub 74, further accelerating the shut-off valve closure. Eventually, the entire cavity formed at the bottom of shut-off valve 60 is acted upon by the pressure of fluid flowing through valve part 36, causing the shut-off valve to seat with a substantial force. There after, static pressure maintains the shut-off valve in contact with the valves seat. Due to the magnitude of the forces involved, the initially orientation of the shut-off valve upon contact with the valve seat is maintained as long as fluid pressure applied to the valve part. It has been observed that the shut-off valve is unable to vibrate, fluctuate or otherwise move to a re-seated position, preserving the initial orientation of the shut-off valve when it first contacts the valve seat. It is important therefor that optima seating of the shut-off valve is obtained at the first instant of closing with valve seat 106. The rounded corner of the shut-off valve and the frusto chronicle valve seating configuration is found unofficial and providing the desirable initial eliminate of the shut-off valve with the valve seat. Further, will be recognized that the concave recess formed at the bottom side of the shut-off valve is important in maintaining a stable path of movement as the shut-off valve is urged toward valve seat 106. As will be appreciated by those skill in the art, the archit. hendge arms 116 which are pined at 102 to the valve part housing are allowed at least a minium freedom of movement to allow the shut-off valve seating surface to seeks its initial line contact with valve seat 106. As a practical consideration, some amount of play of the pine connection 102 is expedient in light of manufacturing intolerances of the components, which are preferably of cast iron construction and large forces associated with the whole conditions involved. As mention, the interboard of valve part 36 of the illustrated embodiment has a 6 inch diameter and contains fluids at flow pressures ranging between 150 and 200 pounds per square inch. Further, the source of fluid pressure is assumed to have a large capacity such that the fluids and flow pressures do not decrease over time, particularly within the time frame of an automatic closing operation. Cordially, it is important that the shut-off valve be confid in a control manner as it moves toward valve seat 106 to assure that initial closing of the shut-off valve results in substantially complete shut-off of fluid flow through valve part 36.

As mentioned, shut-off valve 60 may be provided with a witness hole 82 located at the center of its top wall 62. In the prefer embodiment, with valve pipe 36 having a 6 inch boar, witness hole pd2 has a diameter on the order of ⅛ inch. Due to the relatively small size of the witness hole, and the elevated pressure of the fluid contained within valve part 36, a limited high pressure spray of fluid imitates downstream of the valve part, thus providing a ready visual indication of location of damaged, to repair personnel. A witness hole is also believed to provide some relief of water hammer conditions which may be present in the system at the time of automatic shut-off closure.

1. A pipe coupling having automatic shutoff, comprising: an extension including an extension body with opposed first and second ends, and a flow passageway defined between the first and second ends of said extension body; a valve including a valve body with opposed first and second ends, a valve seat associated with said valve body, and a flow passageway defined between the first and second ends of said valve body; a shutoff valve movably mounted to said valve body for movement toward and away from said valve seat; a bias member between said valve body and said shutoff valve, urging said shutoff valve toward said valve seat; a holding member having opposed first and second ends, extending between said extension body and said shutoff valve, holding said shutoff valve in an open position away from said valve seat; joining means joining said extension body to said valve body so as to bring the flow passageways of said extension body and said valve body into flow communication with one another; and separation means associated with said pipe coupling to separate the joinder of the valve body to at least a portion of the extension body upon application of an impact force to said pipe coupling so as to allow said holding member to move from a position between said extension body and said shutoff valve, allowing said shutoff valve to move toward said valve seat for seating engagement therewith, at least substantially blocking flow through said valve body.

2. The pipe coupling of claim 1 wherein one end of said holding member is joined to said extension body.

3. The pipe coupling of claim 1 wherein one end of said holding member is threaded and said extension body defines a threaded passageway which threading engages the holding member.

4. The pipe coupling of claim 1 wherein said shutoff valve includes a contact surface engaging said holding member, wedging said holding member between said extension body and said shutoff valve.

5. The pipe coupling of claim 1 wherein said shutoff valve includes a top wall with opposed first and second surfaces surrounded by an outer side wall, the side wall and the first surface cooperating to define a seating surface of the shutoff valve.

6. The pipe coupling of claim 5 wherein said first surface and said side wall cooperate to define a concave recess.

7. The pipe coupling of claim 6 wherein, with movement of said shutoff valve toward said valve seat, said concave recess faces the direction of flow through said pipe coupling, so that a flow force urges said shutoff valve into contact with said valve seat.

8. The pipe coupling of claim 6 further comprising a cup member on said top wall opening in the same direction as said concave recess.

9. The pipe coupling of claim 8 wherein said bias member comprises a coil spring having one end engaging said cup member.

10. The pipe coupling of claim 9 wherein said coil spring includes an opposing free end, said coil spring travelling with said shutoff valve as said shutoff valve moves toward said valve seat.

11. A pipe coupling having automatic shutoff, comprising: an extension including an extension body with opposed first and second ends, and a flow passageway defined between the first and second ends of said extension body; a valve including a valve body with opposed first and second ends, a valve seat associated with said valve body, and a flow passageway defined between the first and second ends of said valve body; a shutoff valve movably mounted to said valve body for movement toward and away from said valve seat; a bias member between said valve body and said shutoff valve, urging said shutoff valve toward said valve seat; a holding member having opposed first and second ends, extending between said extension body and said shutoff valve, holding said shutoff valve in an open position away from said valve seat; joining means joining said extension body to said valve body so as to bring the flow passageways of said extension body and said valve body into flow communication with one another; and one of said extension body and said valve body including a weakened portion which fails so as to separate the joinder of the valve body to at least a portion of the extension body upon application of an impact force to said pipe coupling so as to allow said holding member to move from a position between said extension body and said shutoff valve, allowing said shutoff valve to move toward said valve seat for seating engagement therewith, at least substantially blocking flow through said valve body.

12. The pipe coupling of claim 11 wherein said extension body includes a line of weakness comprising said weakened portion.

13. The pipe coupling of claim 12 wherein said line of weakness is located adjacent the second end of said extension body.

14. The pipe coupling of claim 11 wherein said extension body is divided by a line of weakness, comprising a weakened portion, into a first weakened portion and second portion.

15. The pipe coupling of claim 11 wherein the extension body is divided by a line of weakness, comprising said weakened portion, into first and second axially adjacent weakened portions with the second portion joined to said valve body.

16. The pipe coupling of claim 11 wherein said shutoff valve includes a top wall with opposed first and second surfaces surrounded by an outer side wall, the side wall and the first surface cooperating to define a seating surface of the shutoff valve and said first surface and said side wall cooperate to define a concave recess.

17. The pipe coupling of claim 16 wherein, with movement of said shutoff valve toward said valve seat, said concave recess faces the direction of flow through said pipe coupling, so that a flow force urges said shutoff valve into contact with said valve seat.

18. The pipe coupling of claim 16 further comprising a cup member on said top wall opening in the same direction as said concave recess.

19. The pipe coupling of claim 18 wherein said bias member comprises a coil spring having one end engaging said cup member.

20. The pipe coupling of claim 19 wherein said coil spring includes an opposing free end, said coil spring traveling with said shutoff valve as said shutoff valve moves toward said valve seat.
